(19) United States
(12) Patent Application Publication
(10) Pub. No.: US 2012/0191741 A1
(43) Pub. Date: Jul. 26, 2012

(54) System and Method for Detection of Groups of Interest from Travel Data

(75) Inventors: Robert J. Cole, Pa Furnace, PA (US); Geoffrey Guisewite, State College, PA (US); Bryan D. Glick, State College, PA (US)

(73) Assignee: RAYTHEON COMPANY, Waltham, MA (US)

(21) Appl. No.: 13/010,352

(22) Filed: Jan. 20, 2011

(51) Int. Cl. G06F 17/30

(52) U.S. Cl. 707/758; 707/E17.014

(57) ABSTRACT

A system and method for detecting a group of interest from travel information based on a suspect traveler and a co-travel count threshold. The system comprises a database comprised of traveler names, each having respective destinations and corresponding travel dates, and a detection module in communication with the database. The detection module is operable to search the database to determine traveler names having a co-travel count based on the suspect traveler, form a co-travel group based on traveler names having respective co-travel counts greater than or equal to the co-travel count threshold, determine co-travel within said co-travel group, identify cliques within said co-travel group based on said co-travel, and determine the maximal clique thereby detecting the group of interest. The method involves providing a co-travel count threshold, selecting a suspect traveler, and, based on such, detecting a group of interest from travel information.

### TECHNICAL FIELD OF THE DISCLOSURE

This disclosure relates generally to the detection of groups of interest. More particularly, this disclosure relates to a system and method for the detection of groups of interest from travel data.

### BACKGROUND OF THE DISCLOSURE

Many human activities among multiple individuals require coordination in various forms. In some cases, direct face-to-face coordination is needed among a group of people. This coordination may be required repeatedly over the course of time. Assuming an adversary organization is engaging in such coordinated activity, it seems reasonable to speculate that patterns resulting from such repeated coordination could be detectable and hence would allow for the discovery of adversarial groups. One example of where such group of interest detection is desirable is with detecting coordinated group activity based on travel data. It is assumed that travel data in the form of traveler ID, destination and travel date are available for a large set of N people (e.g. flight records for many airlines).

However, the methods and systems currently available today to perform such detections are, in many ways, inadequate. For example, many systems are too parameter constrained to provide an effective detection of groups of interest. Others are resource limited and the detection methodology is slow and inaccurate producing a high rate of false positives. As for one aspect, the problem of using travel data to detect groups of people traveling to a common destination within a time interval (i.e., co-travel) multiple times is shown to be equivalent to detecting complete bipartite sub-graphs in a bipartite graph, a problem known to be NP-complete. A number of approaches have been attempted in the industry, none achieving levels of success that are reliable enough for responsible use. One particular problem needing attention in today's environment, is the detection of groups of travelers that co-travel with each other K times (but not necessarily all at the same time and same location) that is equivalent to clique detection (albeit on a smaller graph), another known NP-complete problem.

Accordingly, there exists a long felt need for an improved system and method for the detection of groups of interest from travel data and/or other types of data that alleviates the inherent problems known in the systems and methods for group detection currently being employed in the various industries today.

### SUMMARY OF THE DISCLOSURE

According to one embodiment of the present disclosure applied to travel data, a system for detecting a group of interest (GoI) based on a suspect traveler and a co-travel count threshold, is presented comprised of a database comprised of traveler names, each having respective destinations and corresponding travel dates, and a detection module in communication with said database. The detection module is operable to search the database to determine traveler names having a co-travel count based on the suspect traveler. From the traveler names having a co-travel count, the detection module is operable to form a co-travel group based on the traveler names having respective co-travel counts greater than or equal to the co-travel count threshold. From the co-travel group, the detection module is operable to determine co-travel within said co-travel group. The detection module is then further operable to identify cliques within the co-travel group based on the co-travel. From the cliques so identified, the detection module determines the maximal clique to thereby detect the GoI.

Accordingly, some embodiments of the disclosure may provide numerous technical advantages. Some embodiments may benefit from some, none or all of these advantages. For example, a potential technical advantage of one embodiment of the disclosure may be an improved and more efficient system and method for detecting groups of interest in information that requires less computational resources and is less time expensive. Another potential technical advantage of one embodiment of the disclosure is that it may provide for an improved system and method for detecting groups of interest in information having more reliable and consistent detection results.

Another example of a potential technical advantage of one embodiment of the present disclosure is that it may alleviate problems associated with false positive detections or otherwise false candidate counts. That is, detecting groups of interest having some members that are not truly a member. Many current group detection systems simply live with these false detections and deal with identifying and removing them with additional resources.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description. The foregoing has outlined rather broadly some of the more pertinent and important advantages of the present disclosure in order that the detailed description of the disclosure that follows may be better understood so that the present contribution to the art can be more fully appreciated. It should be appreciated by those skilled in the art that the conception and the specific embodiment disclosed may be readily utilized as a basis for modifying or designing other structures for carrying out the same purposes of the present disclosure. It should also be realized by those skilled in the art that such equivalent constructions do not depart from the spirit and scope of the present disclosure as set forth in the appended claims.

### BRIEF DESCRIPTION OF THE DRAWINGS

For a fuller understanding of the nature and possible advantages of the present disclosure, reference should be had to the following detailed description taken in connection with the accompanying drawings in which:

FIG. 1 is a block diagram illustrating the various components of one embodiment of a system for detecting a group of interest (GoI) from travel information in accordance with the teachings of the present disclosure;

FIG. 2 is a flowchart showing one embodiment of a series of steps that may be performed by the system of FIG. 1 in accordance with the teachings of the present disclosure;

FIGS. 3A-3F are graphical representations of expected group count contours for various values of L and N resulting from a travel model in accordance with teachings of the present disclosure;

FIG. 4 is a graphical representation of false candidate counts for “k=3” and various values of G resulting from the travel model and used for selecting a co-travel count threshold in accordance with the teachings of the present disclosure; and

FIG. 5 is a graphical representation of false candidate counts for “k=4” and various values of G resulting from the travel model and used for selecting a co-travel count threshold in accordance with the teachings of the present disclosure.

Similar reference characters refer to similar parts throughout the several views of the drawings.

### DETAILED DESCRIPTION OF THE EXAMPLE EMBODIMENTS

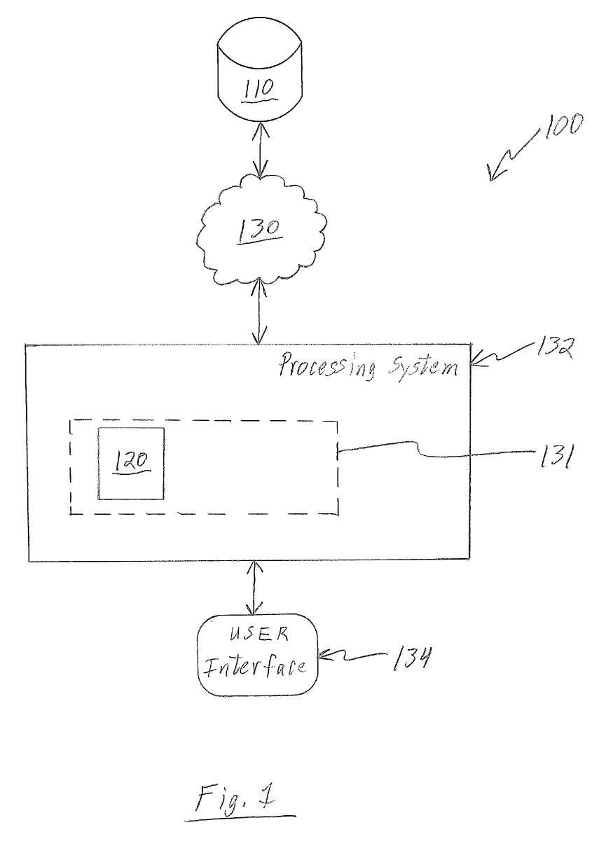

In referring now to FIG. 1, a block diagram can be seen illustrating at a high level the various components of one exemplary embodiment of a system 100 for detecting a group of interest from travel information in accordance with the teachings of the present disclosure. In the particular embodiment of FIG. 1, system 100 is comprised of a database 110 in communication with and accessible by a detection module 120 via a communication path 130.

In the particular embodiment of FIG. 1, the detection module 120 is generally implemented in the form of one or more software modules residing in memory 131 associated with a processing system 132. The detection module 120 can be written as a software program in any appropriate computer language, such as, for example, C, C++, C#, Java, Assembler, Tcl, Lisp, Javascript, or any other suitable language known in the software industry. The processing system may be any suitable type of computing system implemented with a processor capable of executing computer program instructions stored in a memory, which can include a personal computer, a workstation, a network computer, or any other suitable processing device. The memory may be implemented in the form of any memory for reading data from and writing data to and may include any one or combination of memory elements, such as random access memory (RAM), hard drive, tape, compact disc read/write (CD-RW), disk, diskette, cartridge, or the like resident in or associated with the processing system 132. However, in alternative embodiments, it should be understood that detection module 120 may be separately implemented in the form of a number of software modules each residing in the memory associated with an individual standalone processing system and operable to access the database 110 via the communication path 130. The communication path 130 is preferably implemented in the form of a computer network.

The database 110, in the particular embodiment of FIG. 1, is generally implemented in the form of an individual database file residing in the memory associated with a standalone processing system. More particularly, database 110 may be implemented in the form of a plurality of individual processing systems, each having associated memory and one or more database files resident therein such as, for example, a plurality of individual database servers forming a distributed database system. Alternatively, in another embodiment, database 110 may be implemented in the form of a plurality of database files residing in the memory associated with a single standalone processing system. Still further, in another embodiment, database 110 may be implemented in the form of individual database files residing in the same memory associated with the one or more processing systems where the detection module 120 resides and wherein the communication path 130 may be implemented in the form of a bus configured within the one or more processing systems.

The processing system 132, in the embodiment of FIG. 1, preferably further includes a user interface 134 coupled thereto. User interface 134 may be implemented in the form of a display, such as a cathode ray tube (CRT) or liquid crystal display (LCD) screen, and any one or more input devices, such as a keyboard, touchpad, touch screen, a pointing device, a mouse or a joystick providing for interactive control of the processing system 132.

The database 110, in one embodiment, is preferably comprised of various travel information including traveler names with respective destinations and corresponding travel dates. However, it should be understood by those skilled in the art that database 110 may be implemented having any number of additional types of information, including some of which that may not be related to travel. For example, in an alternative embodiment of a more general nature, database 110 in a may simply be comprised of a plurality of entries each of which having one or more attributes and pertaining to any number of other various types of information. The detection module 120 is in communication with the database 110 via the network 130 and operable to perform a series of steps to detect a group of interest based on an established co-travel count threshold and a selected suspect traveler.

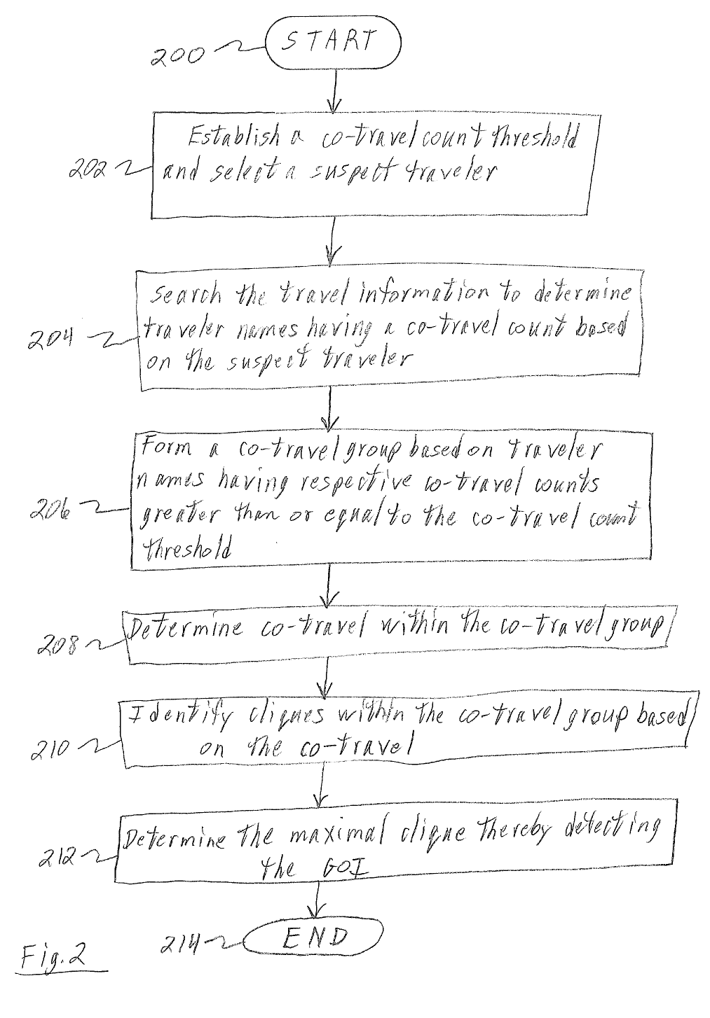

In referring now to FIG. 2, a flowchart showing one embodiment of a series of steps that may be performed by the system of FIG. 1 in accordance with the teachings of the present disclosure. At step 200, the process is initiated. The process may be initiated by applying power to and performing any suitable bootstrapping operations to system 100. At step 202, the detection module 110 receives a suspect traveler and a co-travel count threshold input into system 110 via user interface 134 by a user. Alternatively, in other embodiments, the co-travel count threshold may be implemented as a fixed value set within the configuration of system 100. The co-travel count threshold is generally a value representing the minimum group size to use to detect groups of interest. The co-travel count threshold may preferably be set at a value that is the smallest group size that will produce an acceptable false positive rate for the particular type of GoI detection being attempted. In an alternative embodiment of a more general nature, a comparable step to step 202 may take the form of receiving a suspect entry and an attribute count threshold.

Being an important parameter to system 100, the co-travel count threshold must first be established. This may be accomplished by way of running simulations of test cases with known groups, looking at the false positive results, and then choosing the best fit value for the co-travel count threshold that produces an acceptable false positive rate. However, in order to accomplish this, a random travel model must first be created and then tested by running simulations for a small group size and a minimum number of meetings. In an alternative embodiment, this may be accomplished similarly by choosing the best fit value for an attribute count threshold that produces an acceptable false positive rate. It should be understood by one skilled in the art that when dealing with other types of information, random models for such other types the information equally apply and can likewise be created.

For a random travel model, assume a population of “N” travelers can travel to any of “L” destinations. In each of “T” time intervals, a total of “F” flights occur, each of which travels to one of the “L” locations chosen in a uniformly random manner. Each flight contains “N_{f}” passengers selected randomly (with replacement) in a uniformly random manner from the traveler population. Against this general background of uniform random travel we desire to detect a group of interest (“GoI”) defined as follows: 1) “m-k-Group of Interest” (m-k-GoI) means a set of travelers of size m that has co-traveled at least k times; 2) “Co-travel event” means a group co-travels when every member of the group arrives at the same destination in the same time interval; and 3) “Weak k-co-travel event” means a group weakly k-co-travels when every member of the group k-co-travels with each member of the group (not necessarily at the same time and location).

The variables and events of the model are presented in Table 1 and Table 2.

TABLE 1
Variables

| Variable | Definition |
|---|---|
| N | Number of travelers |
| L | Number of locations |
| F | Number of flights per unit |
| | time |
| N_{f} | Number of people per flight |
| T | Number of time intervals |
| g_{c} | Number of times group g co- |
| | travels |
| cₘ | Number of times a group of |
| | size m co-travels |
| g_{c}ⁱ | Number of times group g co- |
| | travels in time interval i |
| c | Number of groups k-co- |
| | traveling |

TABLE 2
Events

| Event | Definition |
|---|---|
| c_{g}ⁱ | Group g co-travels in a time |
| | interval i |
| gᵢ^{k} | Group i k-co-travels |
| aᵢ^{l} | Traveler i travels in a time |
| | interval to location l |

The above definition of “GoI” hinges on the co-travel concept. Clearly, in order to reliably detect a “GoI”, it is necessary to reliably distinguish genuine “GoIs” from “GoIs” resulting from random chance. To accomplish this, a confidence threshold must be determined. Our starting point is the co-travel event, as this represents the atomic event of analysis, indicating association between a set of travelers.

Distribution of g_{c}

The probability of group co-travel is the joint probability that all group members travel in a given time interval to the same destination. Assuming independence between travelers, and using the definitions given above, the probability of co-travel of a group “g” in a time interval “i” can be expressed as:

$$p ( {g}_{c}^{i} ) = {\sum }_{l = 1}^{L} {\prod }_{i = 1}^{\vert g \vert} p ( {a}_{i}^{l} ) \qquad Equation ( 1 )$$

The probability that traveler “i” travels within a unit time interval to location “l” as dictated by our uniform distribution is given by:

$$p ( {a}_{i}^{l} ) = \frac{{FN}_{f}}{L N}$$

Thus Equation (1) can be expressed as:

$$\begin{matrix}p ( {g}_{c}^{i} ) = {\sum }_{l = 1}^{L} {\prod }_{i = 1}^{\vert g \vert} ( \frac{{FN}_{f}}{L N} ) \\ = {\sum }_{l = 1}^{L} {( \frac{{FN}_{f}}{L N} )}^{\vert g \vert} \\ = {L ( \frac{{FN}_{f}}{L N} )}^{\vert g \vert}\end{matrix} \qquad Equation ( 2 )$$

Define ratio “r”:

$$r ≡ \frac{{FN}_{f}}{N}$$

This ratio represents the proportion of total travelers that travel in a unit interval. Using this definition, Equation (2) becomes:

$$p ( {g}_{c}^{i} ) = {L ( \frac{r}{L} )}^{\vert g \vert} \qquad Equation ( 3 )$$

Equation (3) represents the probability of group co-travel. The probability of co-travel k times in T unit intervals is determined by the binomial distribution where Equation (4) represents the probability of success. Under this distribution, the probability of k co-travel events is given by:

$$p ( {g}_{c} = k ) = ( \begin{matrix}T \\ k\end{matrix} ) {p ( {g}_{c}^{i} )}^{k} {( 1 - p ( {g}_{c}^{i} ) )}^{T - k} \qquad Equation ( 4 )$$

The expected number of successes out of T trials for a binomial distribution with success probability “p” is given by Np. Thus, the expected number of times group “g” co-travels is given by:

$$\begin{matrix}E [ {g}_{c} ] = Tp ( {g}_{c}^{i} ) \\ = {LT ( \frac{r}{L} )}^{\vert g \vert}\end{matrix} \qquad Equation ( 5 )$$

### Expected Number of K-Co-Traveling Groups

The probability of a group “g” k-co-traveling is the probability of this group co-traveling k or more times. Using Equation (4), the probability of this event can be expressed as:

$$\begin{matrix}{p}_{\vert g \vert , k} = p ( {g}_{c} \geq k ) \\ = {\sum }_{j = k}^{N} ( \begin{matrix}T \\ j\end{matrix} ) {p ( {g}_{c}^{i} )}^{j} {( 1 - p ( {g}_{c}^{i} ) )}^{T - j}\end{matrix} \qquad Equation ( 6 a )$$

or, equivalently:

$$\begin{matrix}{p}_{\vert g \vert , k} = p ( {g}_{c} \geq k ) \\ = 1 - {\sum }_{j = 0}^{k - 1} ( \begin{matrix}T \\ j\end{matrix} ) {p ( {g}_{c}^{i} )}^{j} {( 1 - p ( {g}_{c}^{i} ) )}^{T - j}\end{matrix} \qquad Equation ( 6 b )$$

The single-group k-co-travel probability, Equation (6), is a constant for all groups of a given size “m”. Thus, the probability of “n” groups of size “m” k-co-traveling can be expressed as:

$$p ( {c}_{m} = n ) = ( \begin{matrix}{N}_{m} \\ n\end{matrix} ) {p}_{\vert g \vert , k} {}_{}^{n}{( 1 - {p}_{\vert g \vert , k} )}{}_{}^{{N}_{m} - n} \\ where \\ {N}_{m} = ( \begin{matrix}N \\ m\end{matrix} ) \qquad Equation ( 7 )$$

is the number of groups of size “m”. From Equation (7) it follows that the expected number of k-co-traveling groups of size “m” is given by:

E[cₘ]=Nₘp_{|g|,k} Equation (8)

Based upon Equation (8), the expected number of k-co-traveling groups can be bounded as follows:

$$E [ c ] \leq {\sum }_{m = 2}^{N} {N}_{m} {p}_{\vert g \vert , k} \qquad Equation ( 9 )$$

Substituting values into Equation (9), we have:

$$E [ c ] \leq {\sum }_{m = 2}^{N} ( \begin{matrix}N \\ m\end{matrix} ) {\sum }_{j = k}^{N} ( \begin{matrix}T \\ j\end{matrix} ) {{L}^{j} ( \begin{matrix}r \\ L\end{matrix} )}^{jm} {( 1 - {L ( \frac{r}{L} )}^{m} )}^{T - j}$$

Defining “p_{k,m}” as follows:

$${p}_{k , m} ≡ {\sum }_{j = k}^{N} ( \begin{matrix}T \\ j\end{matrix} ) {{L}^{j} ( \frac{r}{L} )}^{jm} {( 1 - {L ( \frac{r}{L} )}^{m} )}^{T - j}$$

then an upper bound for “p_{k,m}” can be expressed as:

$${p}_{k , m} \leq {\sum }_{j = k}^{N} ( \begin{matrix}T \\ j\end{matrix} ) {{L}^{j} ( \frac{r}{L} )}^{jm}$$

### Consequently:

$${p}_{k , m + 1} \leq {\sum }_{j = k}^{N} ( \begin{matrix}T \\ j\end{matrix} ) {{L}^{j} ( \frac{r}{L} )}^{j ( m + 1 )} \leq {\sum }_{j = k}^{N} ( \begin{matrix}T \\ j\end{matrix} ) {{L}^{j} ( \frac{r}{L} )}^{jm} {( \frac{r}{L} )}^{j} \leq {\sum }_{j = k}^{N} ( \begin{matrix}T \\ j\end{matrix} ) {{L}^{j} ( \frac{r}{L} )}^{jm} {( \frac{r}{L} )}^{k} \leq {( \frac{r}{L} )}^{k} {p}_{k , m}$$

and thus:

$$\frac{{p}_{k , m + 1}}{{p}_{k , m}} \leq {( \frac{r}{L} )}^{k} \qquad Equation ( 10 )$$

Using the definition of “p_{k,m}” above, the ratio of “E[cₘ₊₁] to E[cₘ]” can be expressed as:

$$\begin{matrix}\frac{E [ {c}_{m + 1} ]}{E [ {c}_{m} ]} = \frac{( \begin{matrix}N \\ m + 1\end{matrix} ) {p}_{k , m + 1}}{( \begin{matrix}N \\ m\end{matrix} ) {p}_{k , m}} \\ = \frac{N - m}{m + 1} \frac{{p}_{k , m + 1}}{{p}_{k , m}}\end{matrix} \qquad Equation ( 11 )$$

Using Equation (10), Equation (11) can be expressed as:

$$\frac{E [ {c}_{m + 1} ]}{E [ {c}_{m} ]} \leq \frac{N - m}{m + 1} {( \frac{r}{L} )}^{k} \qquad Equation ( 12 )$$

From Equation (9), the expected number of groups is:

$$\begin{matrix}E [ c ] = E [ {c}_{2} ] + E [ {c}_{3} ] + … + E [ {c}_{N} ] \\ = E [ {c}_{2} ] + E [ {c}_{2} ] \frac{E [ {c}_{3} ]}{E [ {c}_{2} ]} + E [ {c}_{3} ] \frac{E [ {c}_{4} ]}{E [ {c}_{3} ]} + … + \\ E [ {c}_{N - 1} ] \frac{E [ {c}_{N} ]}{E [ {c}_{N - 1} ]}\end{matrix}$$

Using Equation (12), the expected number can then be expressed as:

$$E [ c ] \leq E [ {c}_{2} ] + E [ {c}_{2} ] \frac{N - 2}{3} {( \frac{r}{L} )}^{k} + E [ {c}_{3} ] \frac{N - 3}{4} {( \frac{r}{L} )}^{k} + … + E [ {c}_{N - 1} ] \frac{1}{N} {( \frac{r}{L} )}^{k} \qquad Equation ( 13 )$$

Note that the product in Equation (12) has a maximum value for “m=2”. Define “a” as follows:

$$a ≡ \frac{N - 2}{3} {( \frac{r}{L} )}^{k}$$

Using this definition, Equation (13) can then be expressed as:

E[c]≦E[c₂](1+a+a²+ . . . +a^{N-2}) Equation (14)

Using the closed-form expression for the sum of a finite geometric series, Equation (14) can be expressed as:

$$E [ c ] \leq E [ {c}_{2} ] \frac{1 - {a}^{N - 1}}{1 - a} \qquad Equation ( 15 )$$

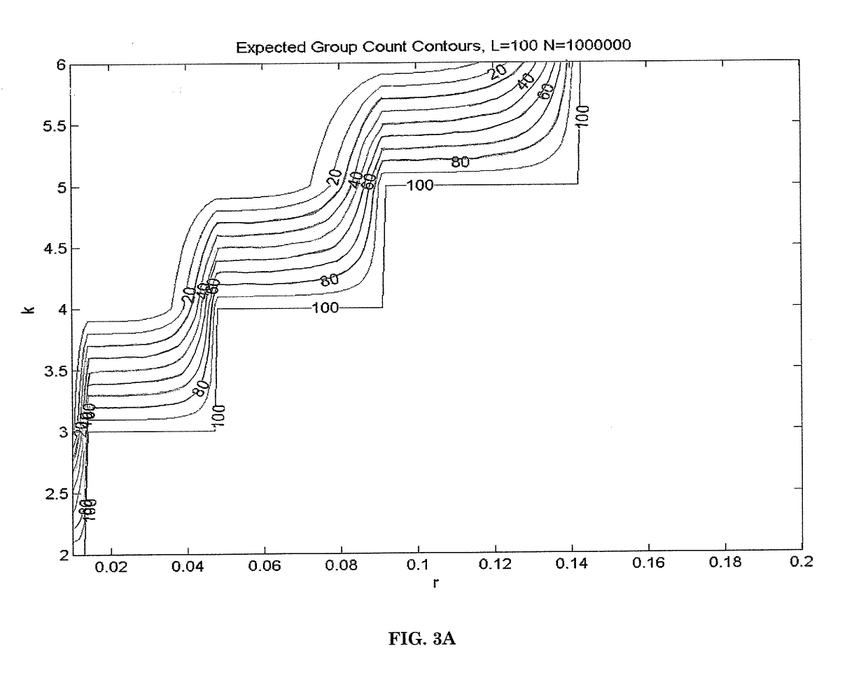

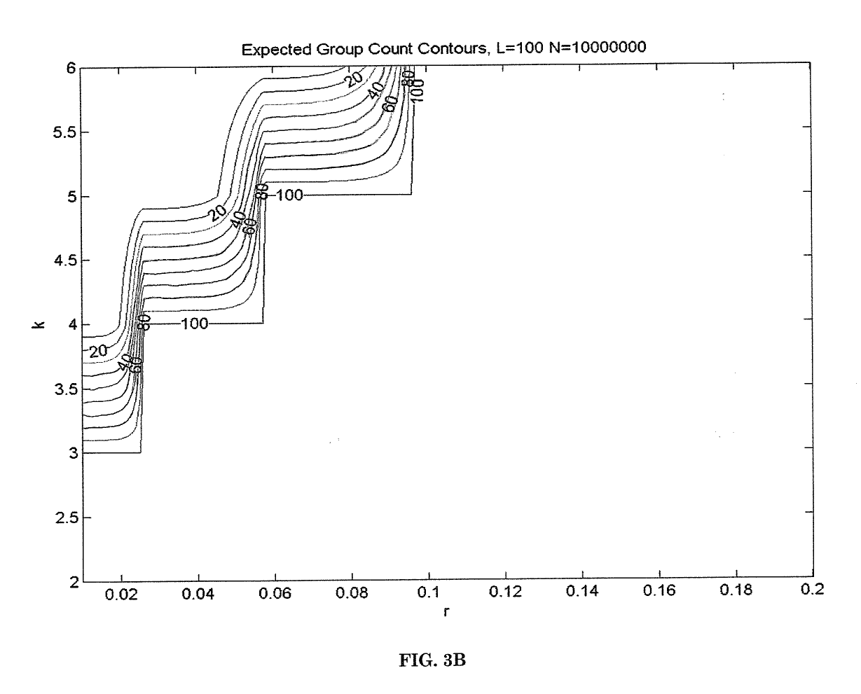

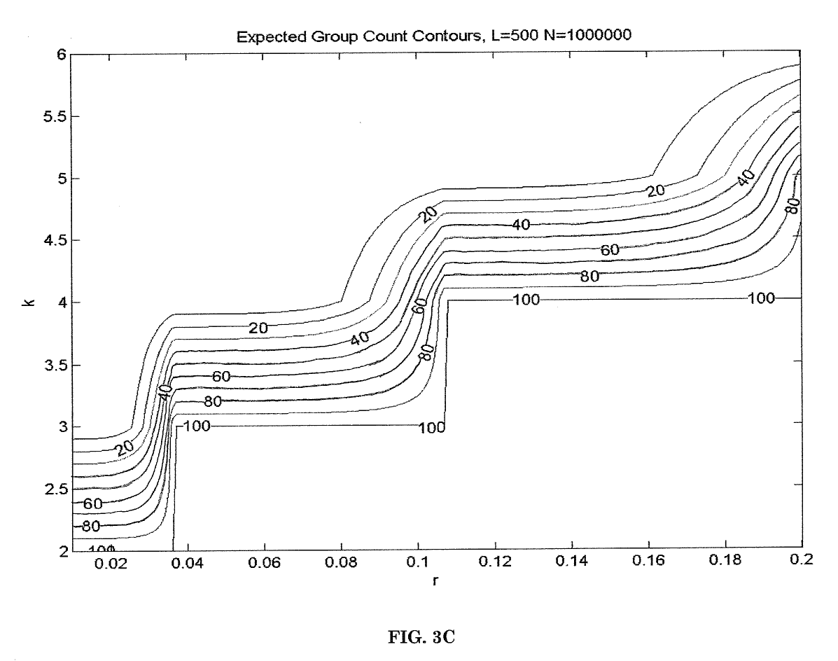

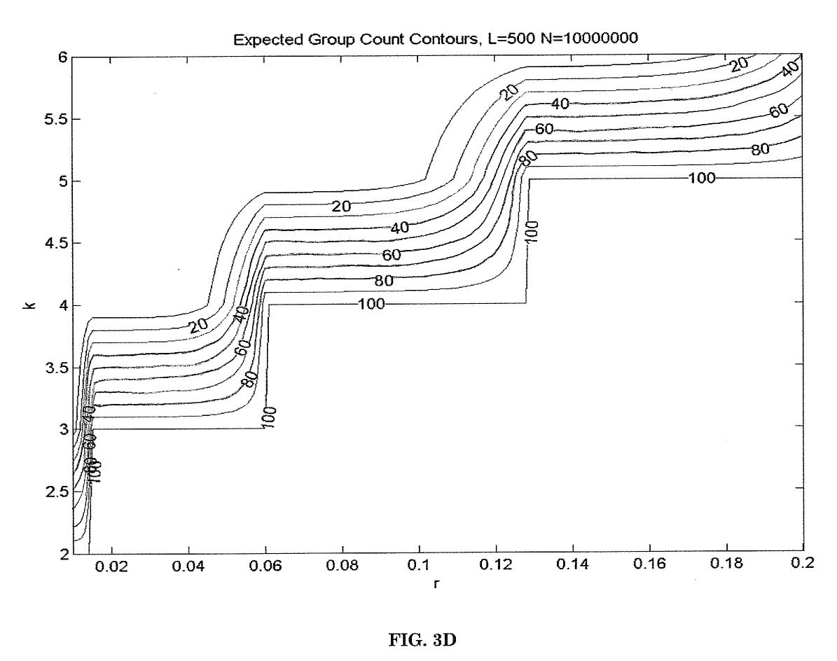

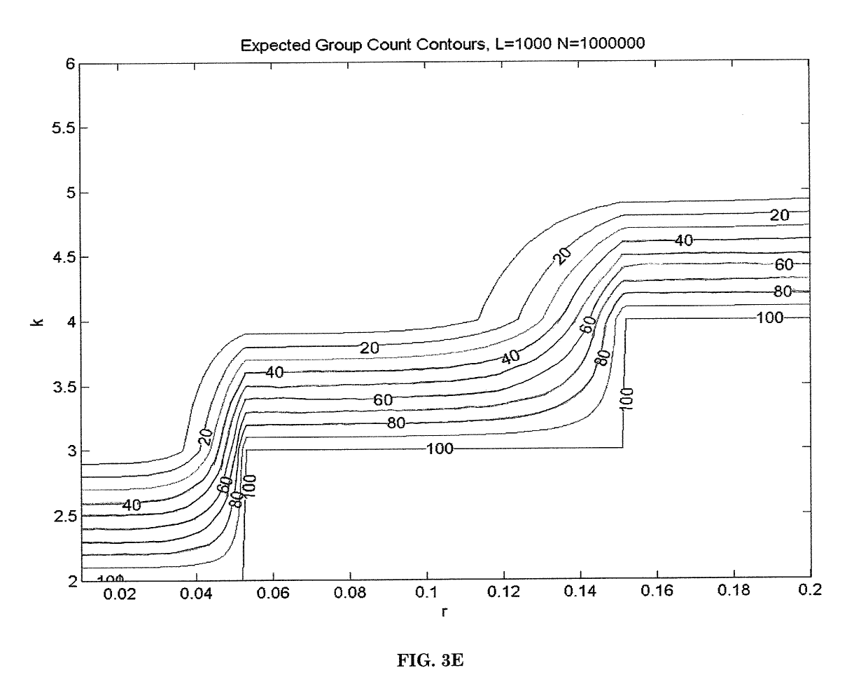

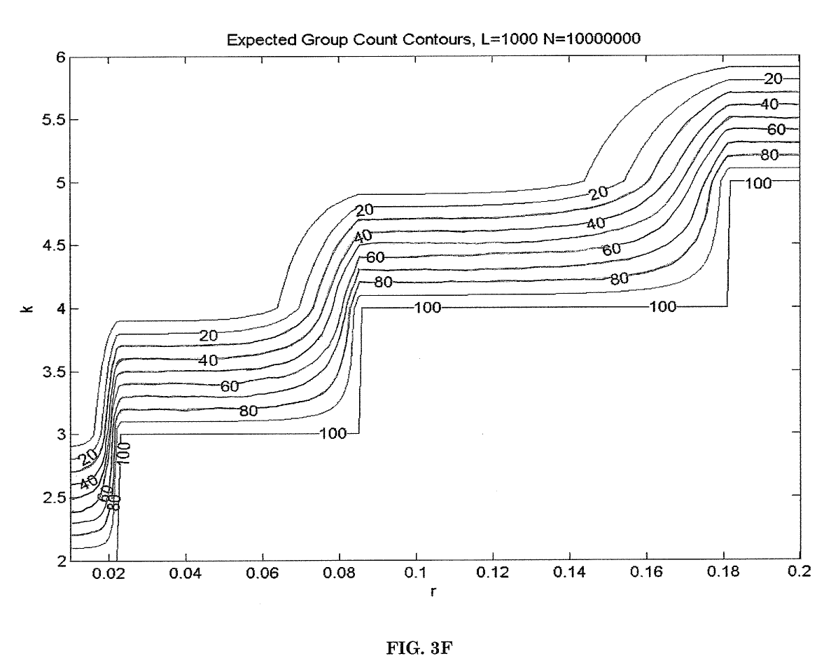

Evaluation of Equation (15) requires the determination of the expected number of k-co-traveling groups of size 2 (namely, “E[c₂]”) using Equations (8) and (6). Expected group counts for various values of L and N are shown as contours in a 2-dimensional space over k and “r” in FIGS. 3A-F. Accordingly, the results illustrated in FIGS. 3A-F indicate that, for the random travel model, detecting small groups of travelers (weakly) co-traveling a small number of times is feasible for a large number of cases. Accordingly, now that a random travel model has been established, simulations can be run to determine a co-travel count threshold.

### Detecting Weak Co-Travel

First, the detection of weak co-travel is considered in view of the random travel model. Using the “weak” co-travel definition, consider the following graph formulation for “weak” m-k-GoI detection:

G=(V, E) where

V=set of all travelers who have k-co-traveled with at least m−1 other travelers

E={(vᵢ, vⱼ)|(vᵢ, vⱼ is in E if and only if traveler vᵢ k-co-traveled with traveler vⱼ}.

Finding an m-k-GoI is equivalent to finding a complete sub-graph with at least “k” vertices in G. This is the clique decision problem. A clique is defined as a sub-graph in which every node has connectivity to every other node in the sub-graph and, under the above definition using nodes and edges, a clique is equivalent to a “GoI”. However, the clique detection problem is known to be NP-complete. That is, it implies we can only guarantee an efficient (time-wise) solution for small problems. Therefore, in order to alleviate the NP-complete condition, we look to detecting “GoI” using a suspect based search where cliques are determined from a smaller graph.

### Suspect-Based Search

Here, a suspect-based “GoI” detection algorithm is proposed. In this approach, an initial suspect traveler is used to obtain a list of candidate “GoI” partners (i.e., traveler names). Against this candidate set of traveler names, a search for cliques is performed to identify the maximal clique in the candidate set of traveler names. Although the need for clique detection remains even in this suspect-based case, the clique search is performed against a much smaller graph than that required in the general case. To complete the determination of the co-travel count threshold in this case, one must first understand the rest of the method of FIG. 2 before running the simulations on the travel model to establish the co-travel count threshold.

In referring now to FIG. 2 again, from step 202, the process moves on to step 204. At step 204, the detection module 120 searches the travel information in the database 110 to determine traveler names having a co-travel count based on the suspect traveler. In one embodiment, detection module 120 may accomplish this step 204 by way of searching the database 110 and matching the destinations and corresponding travel dates for each traveler name with the destinations and corresponding travel dates of the suspect traveler to determine co-travel occurrences and, for each traveler name having one or more co-travel occurrence, calculating a co-travel count equal to the number of co-travel occurrences for that traveler name. For a co-travel occurrence to occur, a traveler name must have traveled to the same destination on the same date as the suspect traveler had traveled.

In an alternative embodiment of a more general nature, addressing other types of information, a comparable step to step 204 may take the form of the detection module 120 searching the information in database 110 to determine entries having an attribute count based on the suspect entry. In such embodiment, the detection model 120 may accomplish this by way of searching the database 110 and matching the attributes for each entry with the attributes of the suspect entry to determine common attribute occurrences and, for each entry having one or more common attribute occurrence, calculating a attribute count equal to the number of common attribute occurrences for that entry. For a common attribute occurrence to occur, an entry must have an attribute identical to an attribute of said suspect entry.

From step 204, the process then moves on to step 206. At step 206, the detection module 120 then takes the list of traveler names having a co-travel count and forms a co-travel group based on those traveler names having respective co-travel counts greater than or equal to the co-travel count threshold. Alternatively, in another embodiment, a comparable step to step 206 may take the form of detection module 120 taking the list of entries having an attribute count and forming a subgroup based on those entries having respective attribute counts greater than or equal to the attribute count threshold. From step 206, the process moves on to step 208.

At step 208, the detection module 120 then determines co-travel within the co-travel group. In one embodiment, detection module 120 may accomplish this step 208 by way of searching the database 110 and matching the destinations and corresponding travel dates for each traveler name in the co-travel group with the destinations and corresponding travel dates associated with each of the other traveler names in the co-travel group to determine co-travel occurrences within the co-travel group. In an alternative embodiment, a comparable step to step 208 may take the form of detection module 120 determining common attributes within the subgroup. This may be accomplished in the alternative embodiment by way of searching the database 110 and matching the attributes for each entry in the subgroup with the attributes associated with each of the other entries in the subgroup to determine common attribute occurrences within the subgroup.

Now that the co-travel has been determined for the traveler names within and among the co-travel group, the process moves on to step 210. At step 210, the detection module 120 then identifies cliques within the co-travel group based on the co-travel determined from step 208. In one embodiment, detection module 120 may accomplish this step 210 by way of first forming a graph representation of the co-travel among the co-travel group wherein the graph representation includes nodes for each traveler name and edges running between the nodes having co-travel occurrences. From the graph representation, the detection module 120 identifies one or more sets of nodes formed of nodes interconnected by equal edges. Each such set of nodes forms one clique.

In an alternative embodiment, a comparable step to step 210 may take the form of detection module 120 identifying cliques within a subgroup based on determined common attribute occurrences. This may be accomplished by way of forming a graph representation of the common attributes among said subgroup, the graph representation including nodes for each entry and edges running between nodes having common attribute occurrences. From the graph representation, the detection module 120 then identifies one or more sets of nodes formed of nodes interconnected by equal edges. Each said set of nodes forms one clique.

From step 210, the process moves to step 212. At step 212, the detection module 120 determines the maximal clique from the cliques identified in step 210. In one embodiment, detection module 120 may accomplish this step 212 by way of determining which clique (i.e., set of nodes), contains the most nodes. The maximal clique thereby forms the “GoI” based on the suspect traveler.

FIG. 2 forms one embodiment of a suspect-based pairwise “GoI” detection method. The method of the embodiment of FIG. 2 addressing the travel scenario can be further represented by the following inputs, output and logic steps as set forth in Table 3.

TABLE 3

```
Inputs:
    suspect traveler s
    set of 3-tuples: (traveler, destination, date)
    co-travel count threshold k
Output:
    maximal GoI containing s
Logic Steps
    v ← get_co_travel_counts(s)
    C ← set of candidates in v where v(i) ≧ k
    for each cᵢ ε C
    pᵢ ← get_co_travel_counts(cᵢ)
  end
    g ← get_candidate_graph(p)
    GoI ← get_maximal_clique(g)
    return GoI
```

### Complexity Analysis

In step 204 of the method of FIG. 2, the detection module 120 performs the equivalent logic step of computing a vector of co-occurrence counts as is represented in Table 3 by “v←get_co_travel_counts(s)”. Assuming a sorted dataset, this step 204 may be performed in O(N) time. In step 206 of the method of FIG. 2, the detection module 120 performs the equivalent logic step of computing the space complexity of “v” and “C” as is represented in Table 3 by “C←set of candidates in v where v(i)≧k” and for which may also be performed in O(N) time. The potentially time consuming steps are the equivalent logic steps to steps 208, 210 and 212. In step 208 of the method of FIG. 2, the detection module 120 performs the equivalent logic step of computing full co-travel count vectors of size N for all candidates which in time and space is O(N|C|) as is represented in Table 3 by “for each cᵢεC, pᵢ←get_co_travel_counts(cᵢ), end”. In step 210 of the method of FIG. 2, the detection module 120 performs the equivalent logic step of computing a graph representation of the co-travel within the co-travel group having space complexity O(|C|²) as is represented in Table 3 by “g←get_candidate_graph(p)”. In step 212 of the method of FIG. 2, the detection module 120 performs the equivalent logic step of where g is processed for a maximal clique as is represented in Table 3 by “GoI←get_maximal_clique(g)”. This logic step has input size of |C| for which cannot be performed in polynomial time and is potentially the most time consuming step. It is now necessary to complete the determination, using the method of FIG. 2 and the equivalent logic steps in Table 3, of an appropriate value for the co-travel count threshold “k” for which to, in part, base the “GoI” detection on for suspect travelers.

From the foregoing complexity analysis, it is clear that the feasibility of the method of FIG. 2 and the logic steps of Table 3 depends on the size of a candidate list of traveler names having a co-travel count for a suspect traveler, |C|, being reasonable. This value is a function of the co-travel count threshold “k”. For a given suspect traveler “s”, we compute the expected number of traveler names having a co-travel count as:

$$E [ \vert C \vert ] = {\sum }_{i = 1}^{N} {\sum }_{j = i + 1}^{N} {v}_{i , j} {p}_{s , i}^{k} \qquad Equation ( 16 )$$

where vᵢ is an indicator variable defined as follows:

$${v}_{i , j} ≅ \{ \begin{matrix}1 & i = s or j = s \\ 0 & otherwise\end{matrix}$$

Since the probability term in Equation (16) is constant, we can express the expected number of traveler names having a co-travel count as:

$$\begin{matrix}E [ \vert C \vert ] = {p}_{s , i}^{k} {\sum }_{i = 1}^{N} {\sum }_{j = i + 1}^{N} {v}_{i , j} \\ = N {p}_{s , i}^{k}\end{matrix} \qquad Equation ( 17 )$$

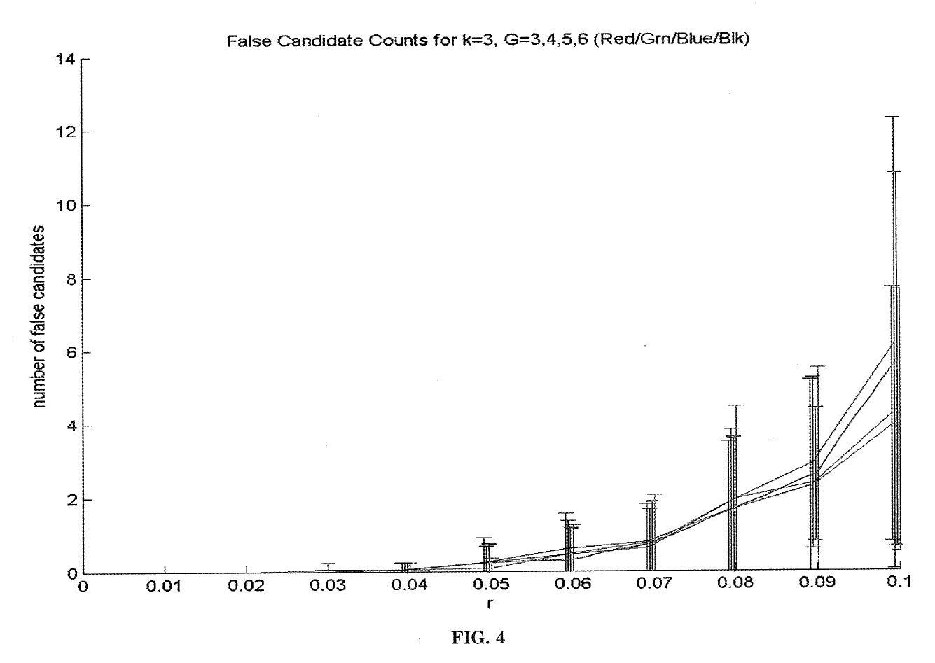

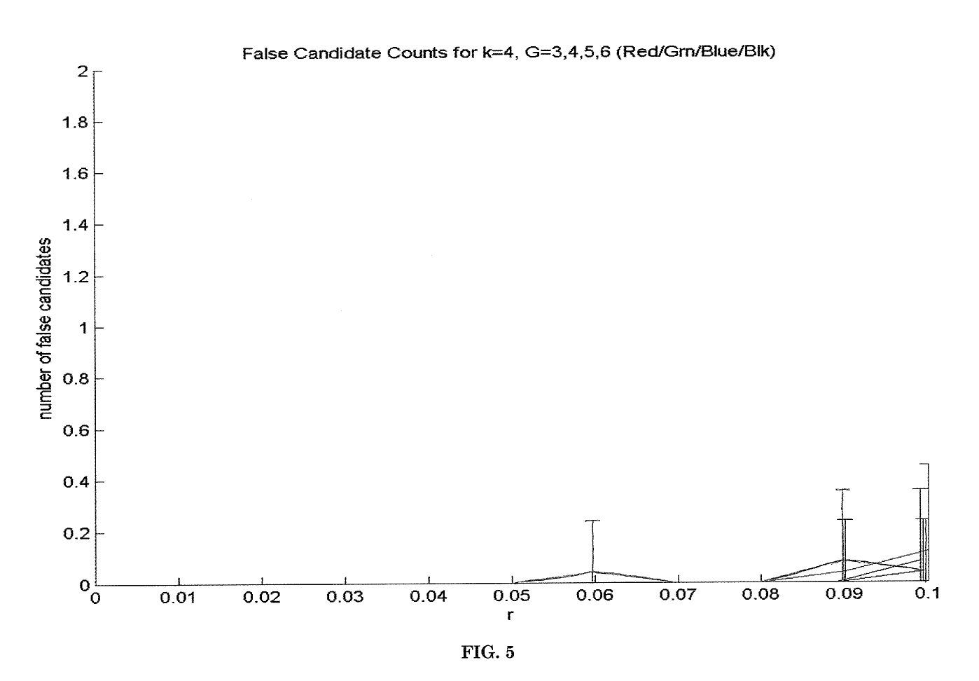

Thus our co-travel count threshold “k” determines the expected number of traveler names having a co-travel count via Equation (17). Assuming it is desirable to keep the list of traveler names having a co-travel count a size in the order of 10E2 or smaller, and given that N is in the order of 10E6 or larger, the co-travel count threshold “k” needs to be such that the probability of co-travel is no larger than in the order of 10E-4. From FIGS. 4 and 5, this can be achieved for small values of “k” under some travel ratios and destination counts.

### Simulation Results

FIGS. 4 and 5 illustrate the number of false candidate counts for values of “k=3” and “k=4” respectively for various values of G resulting from simulations of the travel model. Simulated travel data was generated for purposes of demonstrating the efficacy of the method of FIG. 2 performing the logic steps in Table 3. For this simulation, 4 values of G were used (3, 4, 5 and 6), 3 values of “k” were used (3, 4 and 5) and 10 values of “r” were used (0.01 to 0.10 in increments of 0.01). For each of the 120 combinations of these values of G, “k” and “r”, 25 random trials were run in which the values of L, F and N_{f} were chosen randomly in a uniform manner from the ranges shown in Table 4.

For each trial, a known suspect traveler was identified along with a set of G-1 accomplices. A set of k destinations were randomly selected from the set of L destinations. G travel records of the form (Travelerᵢ, Destinationⱼ, Dateⱼ) were added to the dataset for i=1 . . . G and j=1 . . . k to simulate the coordinated travel of the “GoI” members.

TABLE 4
Variable Ranges

| Variable | Range |
|---|---|
| L | [100 300] |
| F | [50 300] |
| N_{f} | [100 200] |

A total of 3,000 random trials were performed. For each trial, a binary variable was returned indicating whether the method of FIG. 2 performing the logic steps in Table 3 exactly recovered the suspect traveler's group (i.e., the G-1 accomplices). Additionally, the number of travelers (i.e., traveler names) pruned from the suspect traveler's candidate list was measured. These pruned traveler names represent false candidates (i.e., false positives) resulting from random chance.

In 2,992 cases, the method of FIG. 2 performing the logic steps in Table 3 exactly recovered the suspect traveler's true group. The number of false candidates was found to be strongly affected by the co-travel count threshold “k” and the travel proportion “r”. The relationship between these variables can be seen in FIGS. 4 and 5. In FIGS. 4 and 5, 1-sigma error bars are shown for the mean number of false candidates as a function of ratio “r”. The four group count values for G are represented as four curves. Small r-axis offsets were applied to the error bars of the 4 curves to facilitate visualization. FIG. 4 illustrates curves for “k=3” and FIG. 5 illustrates curves for “k=4”. The results for “k=5” were constant across all values of “r” and G with the number of false candidates in the “k=5” case being zero.

### Discussion of Suspect Based Search

The simulation results confirm the overall theoretical prediction: the method of FIG. 2 performing the logic steps in Table 3 can reliably detect “GoIs”. More specifically, the simulation results suggest useful operational ranges of system parameters and give confidence in the performance of the clique identification step. The travel ratio “r” being an important system parameter, whose value is not precisely known, however, may be assumed to be less than 0.1. This assumption is based on the simulation results showing that for “r” less than 0.1 false candidate counts are inconsequential for values of the co-travel count threshold “k” greater than 3 and are small for “k=3”. Based on these simulation results, it is submitted that the teachings of the present disclosure may provide for: 1) Groups of interest as small as 3 being reliably detected given a suspect traveler in the group; and 2) Groups of interest being detected with latency as small as 3 group meetings.

The present disclosure includes that contained in the appended claims, as well as that of the foregoing description. Although this disclosure has been described in its preferred form in terms of certain embodiments with a certain degree of particularity, alterations and permutations of these embodiments will be apparent to those skilled in the art. Accordingly, it is understood that the above descriptions of exemplary embodiments does not define or constrain this disclosure, and that the present disclosure of the preferred form has been made only by way of example and that numerous changes, substitutions, and alterations in the details of construction and the combination and arrangement of parts may be resorted to without departing from the spirit and scope of the invention.

What is claimed is:

1. A method for detecting a group of interest from travel information, the travel information including traveler names with respective destinations and corresponding travel dates, the method comprising the steps of:
searching the travel information to determine traveler names having a co-travel count based on a suspect traveler;
forming a co-travel group based on traveler names having respective co-travel counts greater than or equal to a co-travel count threshold;
determining co-travel within said co-travel group;
identifying cliques within said co-travel group based on said co-travel; and
determining the maximal clique to thereby detect the group of interest.

2. The method of claim 1, wherein the step of searching the travel information comprises matching the destinations and corresponding travel dates for each traveler name with the destinations and corresponding travel dates of said suspect traveler to determine co-travel occurrences and, for each traveler name having one or more co-travel occurrence, calculating a co-travel count equal to the number of co-travel occurrences for that traveler name.

3. The method of claim 2, wherein co-travel occurrence comprises traveling to the same destination on the same date.

4. The method of claim 1, wherein the step of identifying cliques comprises the steps of:
forming a graph representation of the co-travel among said co-travel group, the graph representation including nodes for each traveler name and edges running between nodes having co-travel occurrence; and
identifying, from the graph representation, one or more sets of nodes formed of nodes interconnected by equal edges, whereby each said set of nodes forms one said clique.

5. The method of claim 4, wherein the step of determining the maximal clique is comprised of determining which set of nodes includes the most nodes.

6. The method of claim 3, wherein the step of determining co-travel within said co-travel group is comprised of matching the destinations and corresponding travel dates for each traveler name in said co-travel group with the destinations and corresponding travel dates associated with each of the other traveler names in said co-travel group to determine co-travel occurrences within the co-travel group.

7. A system for detecting a group of interest based on a suspect traveler and a co-travel count threshold, the system comprising:
a database comprised of traveler names, each having respective destinations and corresponding travel dates; and
a detection module in communication with said database, said detection module operable to:
search said database to determine traveler names having a co-travel count based on the suspect traveler;
form a co-travel group based on traveler names having respective co-travel counts greater than or equal to the co-travel count threshold;
determine co-travel within said co-travel group;
identify cliques within said co-travel group based on said co-travel; and
determine the maximal clique to thereby detect the group of interest.

8. The system of claim 7, wherein the detection module operable to search said database comprises the detection module operable to match the destinations and corresponding travel dates for each traveler name with the destinations and corresponding travel dates of said suspect traveler within said database to determine co-travel occurrences and, for each traveler name having one or more co-travel occurrence, calculate a co-travel count equal to the number of co-travel occurrences for that traveler name.

9. The system of claim 8, wherein co-travel occurrence comprises traveling to the same destination on the same date.

10. The system of claim 9, wherein the detection module operable to determine co-travel within said co-travel group comprises the detection module operable to search said database to match the destinations and corresponding travel dates for each traveler name in said co-travel group with the destinations and corresponding travel dates associated with each of the other traveler names in said co-travel group.

11. The system of claim 7, wherein the detection module operable to identify cliques comprises the detection module operable to:
form a graph representation of said co-travel within said co-travel group, the graph representation including nodes for each traveler name and edges running between nodes having said co-travel; and
identify, from the graph representation, one or more sets of nodes formed of nodes interconnected by equal edges, whereby each said set of nodes forms one said clique.

12. The system of claim 11, wherein the detection module operable to determine the maximal clique comprises the detection module operable to determine which set of nodes includes the most nodes.

13. Code embodied in a computer readable storage medium that, when executed by a processor, is operable to:
search a database comprised of travel information, the travel information including traveler names, each having respective destinations and corresponding travel dates, to determine traveler names having a co-travel count based on a suspect traveler;
form a co-travel group based on traveler names having respective co-travel counts greater than or equal to a co-travel count threshold;
determine co-travel among said co-travel group;
identify cliques within said co-travel group; and
determine the maximal clique to thereby detect a group of interest.

14. The code of claim 13, further operable to determine traveler names having a co-travel count by matching the destinations and corresponding travel dates for each traveler name with the destinations and corresponding travel dates of said suspect traveler within said database to determine co-travel occurrences and, for each traveler name having one or more co-travel occurrence, calculate a co-travel count equal to the number of co-travel occurrences for that traveler name.

15. The code of claim 14, further operable to determine co-travel occurrence based on traveling to the same destination on the same date.

16. The code of claim 15, further operable to determine said co-travel within said co-travel group by searching said database to match the destinations and corresponding travel dates for each traveler name in said co-travel group with the destinations and corresponding travel dates associated with each of the other traveler names in said co-travel group.

17. The code of claim 13, further operable to identify said cliques by:
forming a graph representation of said co-travel within said co-travel group, the graph representation including nodes for each traveler name and edges running between nodes having said co-travel; and
identifying, from the graph representation, one or more sets of nodes formed of nodes interconnected by equal edges, whereby each said set of nodes forms one said clique.

18. The code of claim 17, further operable to determine the maximal clique by determining which set of nodes includes the most nodes.

19. A method for detecting a group of interest from information, the information having a plurality of entries with each having attributes associated therewith, the method comprising the steps of:
searching the information to determine entries having an attribute count based on a suspect entry;
forming a subgroup based on entries having respective attribute counts greater than or equal to an attribute count threshold;
determining common attributes within said subgroup;
identifying cliques within said subgroup based on said common attributes; and
determining the maximal clique to thereby detect the group of interest.

20. The method of claim 19, wherein the step of searching the information comprises matching the attributes for each entry with the attributes of said suspect entry to determine common attribute occurrences and, for each entry having one or more common attribute occurrence, calculating an attribute count equal to the number of common attribute occurrences for that entry.

21. The method of claim 20, wherein common attribute occurrence comprises an entry having an attribute identical to an attribute of said suspect entry.

22. The method of claim 19, wherein the step of identifying cliques comprises the steps of:
forming a graph representation of the common attributes among said subgroup, the graph representation including nodes for each entry and edges running between nodes having common attribute occurrence; and
identifying, from the graph representation, one or more sets of nodes formed of nodes interconnected by equal edges, whereby each said set of nodes forms one said clique.

23. The method of claim 22, wherein the step of determining the maximal clique is comprised of determining which set of nodes includes the most nodes.

24. The method of claim 21, wherein the step of determining common attributes within said subgroup is comprised of matching the attributes for each entry in said subgroup with the attributes associated with each of the other entries in said subgroup to determine common attribute occurrences within the subgroup.
